(19) United States
(12) Patent Application Publication
(10) Pub. No.: US 2017/0012964 A1
(43) Pub. Date: Jan. 12, 2017

(54) PROVIDING AUTHENTICATION OF CONTROL INSTRUCTIONS FROM A CONTROL DEVICE TO A REMOTELY-CONTROLLABLE PHYSICAL INTERACTION DEVICE USING A REMOTE CONTROL AUTHENTICATION TOKEN

(71) Applicant: Identity Over IP, Los Angeles, CA (US)

(72) Inventor: Christopher Ceppi, Los Angeles, CA (US)

(73) Assignee: IDENTITY OVER IP, Los Angeles, CA (US)

(21) Appl. No.: 14/867,732

(22) Filed: Sep. 28, 2015

Related U.S. Application Data
(60) Provisional application No. 62/056,816, filed on Sep. 29, 2014.

(51) Int. Cl. H04L 29/06

(52) U.S. Cl. CPC H04L 63/0807; H04L 63/0853

(57) ABSTRACT

Methods and apparatus for providing authentication of control instructions from a control device to a remotely-controllable physical interaction device using a remote control authentication token include receiving a request from a control device for a transmission of a remote control authentication token. Responsive to the request from the control device for the remote control authentication token, an identity of the control device is verified. Verifying the identity of the control device further includes comparing a pairing of a requesting identity credential of the control device and a requesting network context of the control device to expected values of pairings of requesting identity credentials and requesting network contexts, and responsive to verifying the identity of the control device, transmitting the remote control authentication token. Transmitting of the remote control authentication token indicates permission for the control device to send one or more control instructions to a remotely-controllable physical interaction device.

This application claims benefit of priority to U.S. Provisional Patent Application Ser. No. 62/056,816, filed Sep. 29, 2014, entitled “Providing Authentication Of Control Instructions From A Control Device To A Remotely-Controllable Physical Interaction Device Using A Remote Control Authentication Token,” which is hereby incorporated by reference herein in its entirety.

### BACKGROUND

### Description of the Related Art

The Internet of things is going to create immense and diverse demand for security. Many items, including ubiquitous objects from light bulbs to door locks, are connected to the internet by embedding tiny computers into them and adding wireless connectivity.

Unfortunately, these computers lack sufficient processing power to handle antivirus, intrusion detection, firewall, and other protections considered standard on modern computing platforms.

An increasingly large array of devices with remote control capability built into them through embedded computing and network hardware will gradually play a larger role in domestic life, often connected to one another via home-automation systems, creating the potential for hackers to create embarrassing and nerve-wracking havoc.

Likewise, an increasingly large array of devices with remote control capability built into them through embedded computing and network hardware are being deployed in factories, offices, hospitals and commercial spaces, often connected to one another via centralized control networks. That will make them tempting targets for cyber-attackers who desire to do real harm.

### SUMMARY

Various methods and apparatus for providing authentication of control instructions from a control device to a remotely-controllable physical interaction device using a remote control authentication token include receiving a request from a control device for a transmission of a remote control authentication token. Responsive to said request from said control device for said remote control authentication token, an identity of said control device is verified. Verifying the identity of the control device further includes comparing a pairing of a requesting identity credential of said control device and a requesting network context of said control device to expected values of pairings of requesting identity credentials and requesting network contexts, and responsive to verifying said identity of said control device, transmitting said remote control authentication token. Transmitting of the remote control authentication token indicates permission for the control device to send one or more control instructions to a remotely-controllable physical interaction device.

### BRIEF DESCRIPTION OF THE DRAWINGS

FIG. 1 illustrates a system architecture for providing authentication of control instructions from a control device to a remotely-controllable physical interaction device using a remote control authentication token, according to some embodiments.

FIG. 2 depicts a module that may be used for implementing providing authentication of control instructions from a control device to a remotely-controllable physical interaction device using a remote control authentication token, according to some embodiments.

FIG. 3 illustrates a module that may be used for implementing providing authentication of control instructions from a control device to a remotely-controllable physical interaction device using a remote control authentication token, according to some embodiments.

FIG. 4 is a high-level logical flowchart of operations that can be used for implementing providing authentication of control instructions from a control device to a remotely-controllable physical interaction device using a remote control authentication token, according to some embodiments.

FIG. 5 is a high-level logical flowchart of operations that can be used for implementing providing authentication of control instructions from a control device to a remotely-controllable physical interaction device using a remote control authentication token, according to some embodiments.

FIG. 6 is a high-level logical flowchart of operations that can be used for implementing providing authentication of control instructions from a control device to a remotely-controllable physical interaction device using a remote control authentication token, according to some embodiments.

FIG. 7 is a high-level logical flowchart of operations that can be used for implementing providing authentication of control instructions from a control device to a remotely-controllable physical interaction device using a remote control authentication token, according to some embodiments.

FIG. 8 is a high-level logical flowchart of operations that can be used for implementing providing authentication of control instructions from a control device to a remotely-controllable physical interaction device using a remote control authentication token, according to some embodiments.

FIG. 9 is a high-level logical flowchart of operations that can be used for implementing providing authentication of control instructions from a control device to a remotely-controllable physical interaction device using a remote control authentication token, according to some embodiments.

FIG. 10 is a high-level logical flowchart of operations that can be used for implementing providing authentication of control instructions from a control device to a remotely-controllable physical interaction device using a remote control authentication token, according to some embodiments.

FIG. 11 is a high-level logical flowchart of operations that can be used for implementing providing authentication of control instructions from a control device to a remotely-controllable physical interaction device using a remote control authentication token, according to some embodiments.

FIG. 12 illustrates an example computer system that may be used in embodiments for implementing providing authentication of control instructions from a control device to a remotely-controllable physical interaction device using a remote control authentication token.

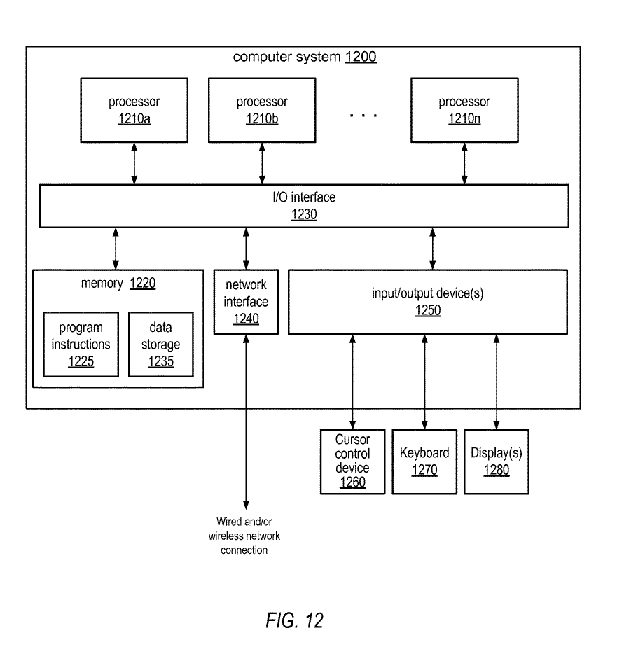

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In some embodiments, an authentication server residing on a network communicates over communication channels with remotely controllable physical interaction devices to allow for receipt and execution by remotely controllable physical interaction devices of commands received from control devices over communication channels.

Some embodiments include a token server for offering token authentication as a remote service. In some embodiments a method for providing authentication of one or more control instructions from a control device to a remotely-controllable physical interaction device using a remote control authentication token includes receiving a request from a control device for a transmission of a remote control authentication token. In some embodiments, the method further includes, responsive to the request from the control device for the remote control authentication token, verifying an identity of the control device. In some embodiments, the verifying the identity of the control device further includes comparing a pairing of a requesting identity credential of the control device and a requesting network context of the control device to expected values of pairings of requesting identity credentials and requesting network contexts. In some embodiments, the method further includes, responsive to verifying the identity of the control device, transmitting the remote control authentication token. In some embodiments, the transmitting of the remote control authentication token indicates permission for the control device to send one or more control instructions to a remotely-controllable physical interaction device.

Some embodiments support whitelisting. In some embodiments, comparing the pairing of the requesting identity credential of the control device and the network context of the control device to expected values of the pairings of requesting identity credentials and requesting network contexts further includes comparing the pairing of the requesting identity credential of the control device and the requesting network context of the control device to expected values of the pairings of requesting identity credentials and requesting network contexts for expected authorized pairings.

Some embodiments support analytics. In some embodiments, comparing the pairing of the requesting identity credential of the control device and the network context of the control device to expected values of the pairings of requesting identity credentials and requesting network contexts further includes comparing the pairing of the requesting identity credential of the control device and the requesting network context of the control device to statistical risk models of expected values of the pairings of requesting identity credentials and requesting network contexts. Some embodiments include an authentication server separate from the token server.

In some embodiments, a method for providing authentication of one or more control instructions from a control device to a remotely-controllable physical interaction device using a remote control authentication token, includes receiving from a remotely-controllable physical interaction device a token authentication request containing the remote control authentication token, verifying an authenticity of the remote control authentication token, and responsive to verifying the authenticity of the remote control authentication token, sending an authenticity verification message to the remotely-controllable physical interaction device. In some embodiments, specific tokens are only authorized for specific command types.

In some embodiments, receiving from a remotely-controllable physical interaction device a token authentication request containing the remote control authentication token further includes receiving from a remotely-controllable physical interaction device a token authentication request containing the remote control authentication token and the one or more control instructions sent to the remotely-controllable physical interaction device. In some embodiments, verifying an authenticity of the remote control authentication token further includes verifying the authenticity of the remote control authentication token with respect to authorization for the one or more control instructions sent to the remotely-controllable physical interaction device.

Some embodiments support authentication differentiated with respect to whether a specific token is authorized from a specific sender identity. In some embodiments, receiving from a remotely-controllable physical interaction device a token authentication request containing the remote control authentication token further includes receiving from a remotely-controllable physical interaction device a token authentication request containing the remote control authentication token and a sending identity credential of the control device sending the one or more control instructions to the remotely-controllable physical interaction device. In some embodiments, verifying an authenticity of the remote control authentication token further includes verifying an authenticity of the remote control authentication token with respect to authorization of the control device sending the one or more control instructions to the remotely-controllable physical interaction device.

In some embodiments, receiving from a remotely-controllable physical interaction device a token authentication request containing the remote control authentication token further includes receiving from a remotely-controllable physical interaction device a token authentication request containing the remote control authentication token and a sending network context of the control device sending the one or more control instructions to the remotely-controllable physical interaction device. In some embodiments, verifying an authenticity of the remote control authentication token further includes verifying an authenticity of the remote control authentication token with respect to authorization of the control device sending the one or more control instructions to the remotely-controllable physical interaction device from the sending network context.

In some embodiments, a method for providing authentication of one or more control instructions from a control device to a remotely-controllable physical interaction device using a remote control authentication token includes receiving at a remotely-controllable physical interaction device one or more control instructions and a remote control authentication token of a sending control device, sending from a server for providing authentication of one or more control instructions from a control device to a remotely-controllable physical interaction device using a remote control authentication token the token authentication request containing the remote control authentication token, and responsive to receiving at the remotely-controllable physical interaction device an authenticity verification message from the server for providing authentication of one or more control instructions from a control device to a remotely-controllable physical interaction device using a remote control authentication token, executing the one or more control instructions on the remotely-controllable physical interaction device.

Some embodiments may include a token authentication module for providing authentication of control instructions from a control device to a remotely-controllable physical interaction device using a remote control authentication token.

The token authentication module may in some embodiments be implemented by a non-transitory, computer-readable storage medium and one or more processors (e.g., CPUs and/or GPUs) of a computing apparatus. In such a token authentication module embodiment, a computer-readable storage medium may store program instructions executable by the one or more processors to cause the computing apparatus to perform receiving at a remotely-controllable physical interaction device one or more control instructions and a remote control authentication token of a sending control device, sending from a server for providing authentication of one or more control instructions from a control device to a remotely-controllable physical interaction device using a remote control authentication token the token authentication request containing the remote control authentication token, and responsive to receiving at the remotely-controllable physical interaction device an authenticity verification message from the server for providing authentication of one or more control instructions from a control device to a remotely-controllable physical interaction device using a remote control authentication token, executing the one or more control instructions on the remotely-controllable physical interaction device and other aspects as described herein.

Other aspects of the token authentication module may in some embodiments be implemented by a non-transitory, computer-readable storage medium and one or more processors (e.g., CPUs and/or GPUs) of a computing apparatus. In such a token authentication module embodiment, a computer-readable storage medium may store program instructions executable by the one or more processors to cause the computing apparatus to perform providing authentication of one or more control instructions from a control device to a remotely-controllable physical interaction device using a remote control authentication token includes receiving a request from a control device for a transmission of a remote control authentication token. In some embodiments, the computer-readable storage medium may store program instructions executable by the one or more processors to cause the computing apparatus to perform, responsive to the request from the control device for the remote control authentication token, verifying an identity of the control device. In some embodiments, the verifying the identity of the control device further includes comparing a pairing of a requesting identity credential of the control device and a requesting network context of the control device to expected values of pairings of requesting identity credentials and requesting network contexts. In some embodiments, the computer-readable storage medium may store program instructions executable by the one or more processors to cause the computing apparatus to perform, responsive to verifying the identity of the control device, transmitting the remote control authentication token. In some embodiments, the transmitting of the remote control authentication token indicates permission for the control device to send one or more control instructions to a remotely-controllable physical interaction device.

Other embodiments of the transaction management module may be at least partially implemented by hardware circuitry and/or firmware stored, for example, in a non-volatile memory or non-transitory computer-readable storage medium.

Some embodiment include a non-transitory computer-readable storage medium storing program instructions. In some embodiments, the program instructions are computer-executable to implement receiving a request from a control device for a transmission of a remote control authentication token. In some embodiments, the program instructions are computer-executable to implement responsive to the request from the control device for the remote control authentication token, verifying an identity of the control device. In some embodiments, the program instructions computer-executable to implement verifying the identity of the control device further include program instructions computer-executable to implement a pairing of a requesting identity credential of the control device and a requesting network context of the control device to expected values of pairings of requesting identity credentials and requesting network contexts. In some embodiments, the program instructions are computer-executable to implement responsive to verifying the identity of the control device, transmitting the remote control authentication token. In some embodiments, the transmitting of the remote control authentication token indicates permission for the control device to send one or more control instructions to a remotely-controllable physical interaction device.

In some embodiments the program instructions computer-executable to implement comparing the pairing of the requesting identity credential of the control device and the network context of the control device to expected values of the pairings of requesting identity credentials and requesting network contexts further include program instructions computer-executable to implement comparing the pairing of the requesting identity credential of the control device and the requesting network context of the control device to expected values of the pairings of requesting identity credentials and requesting network contexts for expected authorized pairings.

In some embodiments, the program instructions computer-executable to implement comparing the pairing of the requesting identity credential of the control device and the network context of the control device to expected values of the pairings of requesting identity credentials and requesting network contexts further include program instructions computer-executable to implement comparing the pairing of the requesting identity credential of the control device and the requesting network context of the control device to statistical risk models of expected values of the pairings of requesting identity credentials and requesting network contexts.

Some embodiments include non-transitory computer-readable storage medium storing program instructions for providing authentication of one or more control instructions from a control device to a remotely-controllable physical interaction device using a remote control authentication token, wherein the program instructions are computer-executable to implement receiving from a remotely-controllable physical interaction device a token authentication request containing the remote control authentication token, verifying an authenticity of the remote control authentication token; and, responsive to verifying the authenticity of the remote control authentication token, sending an authenticity verification message to the remotely-controllable physical interaction device.

In some embodiments the program instructions computer-executable to implement receiving from a remotely-controllable physical interaction device a token authentication request containing the remote control authentication token further include program instructions computer-executable to implement receiving from a remotely-controllable physical interaction device a token authentication request containing the remote control authentication token and the one or more control instructions sent to the remotely-controllable physical interaction device. \

In some embodiments the program instructions computer-executable to implement verifying an authenticity of the remote control authentication token further include program instructions computer-executable to implement verifying the authenticity of the remote control authentication token with respect to authorization for the one or more control instructions sent to the remotely-controllable physical interaction device.

In some embodiments the program instructions computer-executable to implement receiving from a remotely-controllable physical interaction device a token authentication request containing the remote control authentication token further include program instructions computer-executable to implement receiving from a remotely-controllable physical interaction device a token authentication request containing the remote control authentication token and a sending identity credential of the control device sending the one or more control instructions to the remotely-controllable physical interaction device. In some embodiments the program instructions computer-executable to implement verifying an authenticity of the remote control authentication token further include program instructions computer-executable to implement verifying an authenticity of the remote control authentication token with respect to authorization of the control device sending the one or more control instructions to the remotely-controllable physical interaction device.

In some embodiments the program instructions computer-executable to implement receiving from a remotely-controllable physical interaction device a token authentication request containing the remote control authentication token further include program instructions computer-executable to implement receiving from a remotely-controllable physical interaction device a token authentication request containing the remote control authentication token and a sending network context of the control device sending the one or more control instructions to the remotely-controllable physical interaction device. In some embodiments the program instructions computer-executable to implement verifying an authenticity of the remote control authentication token further include program instructions computer-executable to implement verifying an authenticity of the remote control authentication token with respect to authorization of the control device sending the one or more control instructions to the remotely-controllable physical interaction device from the sending network context.

Some embodiments include a non-transitory computer-readable storage medium storing program instructions for providing authentication of one or more control instructions from a control device to a remotely-controllable physical interaction device using a remote control authentication token, wherein the program instructions are computer-executable to implement, receiving at a remotely-controllable physical interaction device one or more control instructions and a remote control authentication token of a sending control device, sending from a server for providing authentication of one or more control instructions from a control device to a remotely-controllable physical interaction device using a remote control authentication token the token authentication request containing the remote control authentication token, and responsive to receiving at the remotely-controllable physical interaction device an authenticity verification message from the server for providing authentication of one or more control instructions from a control device to a remotely-controllable physical interaction device using a remote control authentication token, executing the one or more control instructions on the remotely-controllable physical interaction device.

Some embodiments provide a system for providing authentication of one or more control instructions from a control device to a remotely-controllable physical interaction device using a remote control authentication token. In some embodiments, the system includes a processor and a non-transitory computer-readable storage medium storing program instructions. In some embodiments the program instructions are executable by the processor to implement receiving a request from a control device for a transmission of a remote control authentication token. In some embodiments the program instructions are executable by the processor to implement: responsive to the request from the control device for the remote control authentication token, verifying an identity of the control device. In some embodiments, the program instructions executable by the processor to implement verifying the identity of the control device further include program instructions executable by the processor to implement comparing a pairing of a requesting identity credential of the control device and a requesting network context of the control device to expected values of pairings of requesting identity credentials and requesting network contexts. In some embodiments the program instructions are executable by the processor to implement: responsive to verifying the identity of the control device, transmitting the remote control authentication token. In some embodiments the transmitting of the remote control authentication token indicates permission for the control device to send one or more control instructions to a remotely-controllable physical interaction device.

In some embodiments the program instructions executable by the processor to implement comparing the pairing of the requesting identity credential of the control device and the network context of the control device to expected values of the pairings of requesting identity credentials and requesting network contexts further include program instructions executable by the processor to implement comparing the pairing of the requesting identity credential of the control device and the requesting network context of the control device to expected values of the pairings of requesting identity credentials and requesting network contexts for expected authorized pairings.

In some embodiments the program instructions executable by the processor to implement comparing the pairing of the requesting identity credential of the control device and the network context of the control device to expected values of the pairings of requesting identity credentials and requesting network contexts further include program instructions executable by the processor to implement comparing the pairing of the requesting identity credential of the control device and the requesting network context of the control device to statistical risk models of expected values of the pairings of requesting identity credentials and requesting network contexts.

Some embodiments provide a system for providing authentication of one or more control instructions from a control device to a remotely-controllable physical interaction device using a remote control authentication token. In some embodiments, the system includes a processor and a non-transitory computer-readable storage medium storing program instructions. In some embodiments the program instructions are executable by the processor to implement receiving from a remotely-controllable physical interaction device a token authentication request containing the remote control authentication token, verifying an authenticity of the remote control authentication token, and responsive to verifying the authenticity of the remote control authentication token, sending an authenticity verification message to the remotely-controllable physical interaction device.

In some embodiments the program instructions executable by the processor to implement receiving from a remotely-controllable physical interaction device a token authentication request containing the remote control authentication token further include program instructions executable by the processor to implement receiving from a remotely-controllable physical interaction device a token authentication request containing the remote control authentication token and the one or more control instructions sent to the remotely-controllable physical interaction device. In some embodiments the program instructions executable by the processor to implement verifying an authenticity of the remote control authentication token further include program instructions executable by the processor to implement verifying the authenticity of the remote control authentication token with respect to authorization for the one or more control instructions sent to the remotely-controllable physical interaction device.

In some embodiments the program instructions executable by the processor to implement receiving from a remotely-controllable physical interaction device a token authentication request containing the remote control authentication token further include program instructions executable by the processor to implement receiving from a remotely-controllable physical interaction device a token authentication request containing the remote control authentication token and a sending identity credential of the control device sending the one or more control instructions to the remotely-controllable physical interaction device. In some embodiments the program instructions executable by the processor to implement verifying an authenticity of the remote control authentication token further include program instructions executable by the processor to implement verifying an authenticity of the remote control authentication token with respect to authorization of the control device sending the one or more control instructions to the remotely-controllable physical interaction device.

In some embodiments the program instructions executable by the processor to implement receiving from a remotely-controllable physical interaction device a token authentication request containing the remote control authentication token further include program instructions executable by the processor to implement receiving from a remotely-controllable physical interaction device a token authentication request containing the remote control authentication token and a sending network context of the control device sending the one or more control instructions to the remotely-controllable physical interaction device. In some embodiments the program instructions executable by the processor to implement verifying an authenticity of the remote control authentication token further include program instructions executable by the processor to implement verifying an authenticity of the remote control authentication token with respect to authorization of the control device sending the one or more control instructions to the remotely-controllable physical interaction device from the sending network context.

Some embodiments provide a system for providing authentication of one or more control instructions from a control device to a remotely-controllable physical interaction device using a remote control authentication token. In some embodiments, the system includes a processor and a non-transitory computer-readable storage medium storing program instructions. In some embodiments the program instructions are executable by the processor to implement receiving at a remotely-controllable physical interaction device one or more control instructions and a remote control authentication token of a sending control device, sending from a server for providing authentication of one or more control instructions from a control device to a remotely-controllable physical interaction device using a remote control authentication token the token authentication request containing the remote control authentication token, and responsive to receiving at the remotely-controllable physical interaction device an authenticity verification message from the server for providing authentication of one or more control instructions from a control device to a remotely-controllable physical interaction device using a remote control authentication token, executing the one or more control instructions on the remotely-controllable physical interaction device.

### Example Implementations

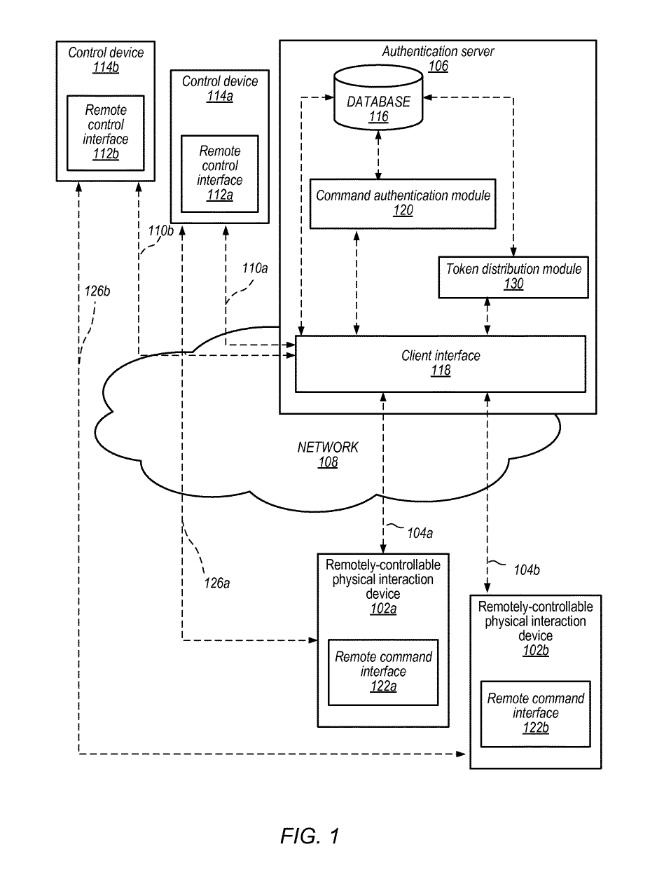

FIG. 1 illustrates a system architecture for providing authentication of control instructions from a control device to a remotely-controllable physical interaction device using a remote control authentication token, according to some embodiments. In some embodiments, an authentication server 106 residing on a network 108 communicates over communication channels 104a-b with remotely controllable physical interaction devices 102a-b to allow for receipt and execution by remotely controllable physical interaction devices 102a-b of commands received from control devices 114a-b over communication channels 126a-b.

In some embodiments, authentication server includes a command authentication module 120 for verifying an identity of the control device using a database 116 reflecting various authorization and token pairings. A client interface 118 coordinates communication of token distribution module 130 and command authentication module 120 with remotely controllable physical interaction devices 102a-b over communication channels 104a-b as well as control devices 114a-b over communication channels 110a-b.

In some embodiments control devices 114a-b, such as industrial automation clients, include remote control interfaces 112a-b that communicate over communication channels 110a-b token requests (e.g., requests for tokens of permission to send authorized commands to remotely controllable physical interaction devices 102a-b over communication channels 126a-b) to token distribution module 130 through client interface 118. Upon receipt of a token request from one of control devices 114a-b, token distribution module 130 compares the received request to stored authorized requests listed in database 116 that are authorized to be fulfilled. If the request from the one of control devices 114a-b is authorized to be fulfilled, then token distribution module 130 sends a token over communication channels 110a-b to remote control interfaces 112a-b for subsequent use by control devices 114a-b in sending commands over communication channels 126a-b to remotely controllable physical interaction devices 102a-b.

In some embodiments, token distribution module 130 can ascertain whether to grant requests for tokens of permission to send authorized commands to remotely controllable physical interaction devices 102a-b over communication channels 126a-b based on various factors. For example, requests for tokens of permission to send authorized commands to remotely controllable physical interaction devices 102a-b over communication channels 126a-b can be considered based on one or a combination of hardware platform identification of control devices 114a-b, network context of control devices 114a-b, user identification (logged into associated with control devices 114a-b) requests for tokens of permission to send authorized commands to remotely controllable physical interaction devices 102a-b over communication channels 126a-b, time of day, type of command, and algorithmic risk analysis by token distribution module.

Upon receipt of tokens of permission to send authorized commands to remotely controllable physical interaction devices 102a-b over communication channels 126a-b, remote control interfaces 112a-b can send commands to remotely controllable physical interaction devices 102a-b along with tokens of permission to send authorized commands to remotely controllable physical interaction devices 102a-b over communication channels 126a-b.

Remote command interfaces 122a-b of remotely controllable physical interaction devices 102a-b receive commands to remotely controllable physical interaction devices 102a-b along with tokens of permission to send authorized commands to remotely controllable physical interaction devices 102a-b over communication channels 126a-b. Remotely controllable physical interaction devices 102a-b then send token verification requests over communication channels 104a-b to command authentication module 120.

Upon receipt of token verification requests from remotely controllable physical interaction devices 102a-b, command authentication module 120 verifies that a particular token is currently authorized in association with a particular command to a particular one of remotely controllable physical interaction devices 102a-b from a particular one of control devices 114a-b and sends token verifications over communication channels 104a-b indicating permission for control devices 114a-b to send authorized commands to remotely controllable physical interaction devices 102a-b over communication channels 126a-b.

Upon receipt of token verifications over communication channels 104a-b indicating permission for control devices 114a-b to send authorized commands to remotely controllable physical interaction devices 102a-b over communication channels 126a-b, remotely controllable physical interaction devices 102a-b execute the commands to remotely controllable physical interaction devices 102a-b received over communication channels 126a-b.

An example of the process described above may provide clarification. Assume control devices 114a-b are tablet computers carried by nurses for taking data from and providing commands to remotely controllable physical interaction devices 102a-b, which are diagnostic and treatment devices in a hospital.

When nurses log in for a shift and activate control devices 114a-b (tablet computers for taking data from and providing commands to remotely controllable physical interaction devices 102a-b), use remote control interfaces 112a-b to communicate over communication channels 110a-b token requests (e.g., requests for tokens of permission to send authorized commands to remotely controllable physical interaction devices 102a-b over communication channels 126a-b to perform tasks such as the reporting of data for specific patients and the administration of treatment (e.g., drug doses through a drug dispensing apparatus) to token distribution module 130 through client interface 118.

Upon receipt of a token request from one of control devices 114a-b (tablets), token distribution module 130 compares the received request (for permission to take patient data on a patient and administer drugs to that patient) to stored authorized requests listed in database 116 that are authorized to be fulfilled. For example, database 116 can include a listing of drugs authorized to be distributed by remotely controllable physical interaction devices 102a-b (drug dispensers) to specific patients associated with those devices and the nurses whose control devices 114a-b (tablet computers identified by specific device ID, login of nurse using the device), are authorized to issue commands and control instructions to the remotely controllable physical interaction devices 102a-b in specific contexts (e.g., location of the device on a particular network at a particular time). For example, a tablet associated with a particular nurse could be authorized to order a dose of pain killer to a particular patient during the nurse's shift, if the tablet is located in the LAN of a particular maternity ward. But the tablet associated with that nurse could be forbidden from ordering other drugs, ordering drugs for other patients, ordering from the breakroom outside the ward, or ordering when the nurse is not on shift.

If the request from the one of control devices 114a-b (nurse's tablet) is listed in the database as being authorized to be fulfilled, then token distribution module 130 sends a token over communication channels 110a-b (e.g., the hospital LAN) to remote control interfaces 112a-b (on the nurse's table) for subsequent use by control devices 114a-b (table) in sending commands over communication channels 126a-b (for example, near field-communication or blue tooth) to remotely controllable physical interaction devices 102a-b (drug dispensing robots).

In some embodiments, token distribution module 130 can ascertain whether to grant requests for tokens of permission to send authorized commands to remotely controllable physical interaction devices 102a-b (the drug dispensing robots) over communication channels 126a-b based on various factors. For example, requests for tokens of permission to send authorized commands to remotely controllable physical interaction devices 102a-b (the drug dispensing robots) over communication channels 126a-b can be considered based on one or a combination of hardware platform identification of control devices 114a-b (e.g., the MAC address of a particular tablet or a hardware serial number), network context of control devices 114a-b (the LAN in the ward as opposed to the LAN in the breakroom), user identification (login ID of the nurse logged into or associated with one of tablet control devices 114a-b) requests for tokens of permission to send authorized commands to remotely controllable physical interaction devices 102a-b over communication channels 126a-b, time of day, type of command, and algorithmic risk analysis by token distribution module.

Upon receipt of tokens of permission to send authorized commands to remotely controllable physical interaction devices 102a-b (the drug dispensing robots) over communication channels 126a-b, remote control interfaces 112a-b (tablets) can send commands to remotely controllable physical interaction devices 102a-b (the drug dispensing robots) along with tokens of permission to send authorized commands to remotely controllable physical interaction devices 102a-b over communication channels 126a-b (near field communication, Bluetooth, a wireless network of the hospital).

Remote command interfaces 122a-b of remotely controllable physical interaction devices 102a-b (the drug dispensing robots) receive commands to remotely controllable physical interaction devices 102a-b (e.g., ordering the drug dispensing robots to dispense morphine) along with tokens of permission to send authorized commands to remotely controllable physical interaction devices 102a-b (the drug dispensing robots) over communication channels 126a-b (e.g., NFC, LAN, Bluetooth). Remotely controllable physical interaction devices 102a-b (the drug dispensing robots) then send token verification requests over communication channels 104a-b to command authentication module 120.

Upon receipt of token verification requests from remotely controllable physical interaction devices 102a-b (the drug dispensing robots), command authentication module 120 verifies that a particular token is currently authorized in association with a particular command to a particular one of remotely controllable physical interaction devices 102a-b (the drug dispensing robots) from a particular one of control devices 114a-b (tablets) and sends token verifications over communication channels 104a-b (network) indicating permission for control devices 114a-b (tablets) to send authorized commands to remotely controllable physical interaction devices 102a-b (the drug dispensing robots) over communication channels 126a-b (NFC, LAN, Wi-Fi).

Upon receipt of token verifications over communication channels 104a-b indicating permission for control devices 114a-b (tablets) to send authorized commands (to dispense drugs) to remotely controllable physical interaction devices 102a-b (the drug dispensing robots) over communication channels 126a-b, remotely controllable physical interaction devices 102a-b (the drug dispensing robots) execute the commands to (to dispense drugs) remotely controllable physical interaction devices 102a-b (the drug dispensing robots) received over communication channels 126a-b (NFC, LAN, Wi-Fi).

An example of the process described above may provide clarification. Assume control devices 114a-b are tablet computers carried by nurses for taking data from and providing commands to remotely controllable physical interaction devices 102a-b, which are diagnostic and treatment devices in a hospital.

When nurses log in for a shift and activate control devices 114a-b (tablet computers for taking data from and providing commands to remotely controllable physical interaction devices 102a-b), use remote control interfaces 112a-b to communicate over communication channels 110a-b token requests (e.g., requests for tokens of permission to send authorized commands to remotely controllable physical interaction devices 102a-b over communication channels 126a-b to perform tasks such as the reporting of data for specific patients and the administration of treatment (e.g., drug doses through a drug dispensing apparatus) to token distribution module 130 through client interface 118.

Upon receipt of a token request from one of control devices 114a-b (tablets), token distribution module 130 compares the received request (for permission to take patient data on a patient and administer drugs to that patient) to stored authorized requests listed in database 116 that are authorized to be fulfilled. For example, database 116 can include a listing of drugs authorized to be distributed by remotely controllable physical interaction devices 102a-b (drug dispensers) to specific patients associated with those devices and the nurses whose control devices 114a-b (tablet computers identified by specific device ID, login of nurse using the device), are authorized to issue commands and control instructions to the remotely controllable physical interaction devices 102a-b in specific contexts (e.g., location of the device on a particular network at a particular time). For example, a tablet associated with a particular nurse could be authorized to order a dose of pain killer to a particular patient during the nurse's shift, if the tablet is located in the LAN of a particular maternity ward. But the tablet associated with that nurse could be forbidden from ordering other drugs, ordering drugs for other patients, ordering from the breakroom outside the ward, or ordering when the nurse is not on shift.

If the request from the one of control devices 114a-b (nurse's tablet) is listed in the database as being authorized to be fulfilled, then token distribution module 130 sends a token over communication channels 110a-b (e.g., the hospital LAN) to remote control interfaces 112a-b (on the nurse's table) for subsequent use by control devices 114a-b (table) in sending commands over communication channels 126a-b (for example, near field-communication or blue tooth) to remotely controllable physical interaction devices 102a-b (drug dispensing robots).

In some embodiments, token distribution module 130 can ascertain whether to grant requests for tokens of permission to send authorized commands to remotely controllable physical interaction devices 102a-b (the drug dispensing robots) over communication channels 126a-b based on various factors. For example, requests for tokens of permission to send authorized commands to remotely controllable physical interaction devices 102a-b (the drug dispensing robots) over communication channels 126a-b can be considered based on one or a combination of hardware platform identification of control devices 114a-b (e.g., the MAC address of a particular tablet or a hardware serial number), network context of control devices 114a-b (the LAN in the ward as opposed to the LAN in the breakroom), user identification (login ID of the nurse logged into or associated with one of tablet control devices 114a-b) requests for tokens of permission to send authorized commands to remotely controllable physical interaction devices 102a-b over communication channels 126a-b, time of day, type of command, and algorithmic risk analysis by token distribution module.

Upon receipt of tokens of permission to send authorized commands to remotely controllable physical interaction devices 102a-b (the drug dispensing robots) over communication channels 126a-b, remote control interfaces 112a-b (tablets) can send commands to remotely controllable physical interaction devices 102a-b (the drug dispensing robots) along with tokens of permission to send authorized commands to remotely controllable physical interaction devices 102a-b over communication channels 126a-b (near field communication, Bluetooth, a wireless network of the hospital).

Remote command interfaces 122a-b of remotely controllable physical interaction devices 102a-b (the drug dispensing robots) receive commands to remotely controllable physical interaction devices 102a-b (e.g., ordering the drug dispensing robots to dispense morphine) along with tokens of permission to send authorized commands to remotely controllable physical interaction devices 102a-b (the drug dispensing robots) over communication channels 126a-b (e.g., NFC, LAN, Bluetooth). Remotely controllable physical interaction devices 102a-b (the drug dispensing robots) then send token verification requests over communication channels 104a-b to command authentication module 120.

Upon receipt of token verification requests from remotely controllable physical interaction devices 102a-b (the drug dispensing robots), command authentication module 120 verifies that a particular token is currently authorized in association with a particular command to a particular one of remotely controllable physical interaction devices 102a-b (the drug dispensing robots) from a particular one of control devices 114a-b (tablets) and sends token verifications over communication channels 104a-b (network) indicating permission for control devices 114a-b (tablets) to send authorized commands to remotely controllable physical interaction devices 102a-b (the drug dispensing robots) over communication channels 126a-b (NFC, LAN, Wi-Fi).

Upon receipt of token verifications over communication channels 104a-b indicating permission for control devices 114a-b (tablets) to send authorized commands (to dispense drugs) to remotely controllable physical interaction devices 102a-b (the drug dispensing robots) over communication channels 126a-b, remotely controllable physical interaction devices 102a-b (the drug dispensing robots) execute the commands to (to dispense drugs) remotely controllable physical interaction devices 102a-b (the drug dispensing robots) received over communication channels 126a-b (NFC, LAN, Wi-Fi).

An alternative example of the process described above may provide additional clarification. Assume control devices 114a-b are remote flight supervision computers operated by drone pilots for taking data from and providing commands to remotely controllable physical interaction devices 102a-b, which are missile-armed drone aircraft.

When drone pilots log in for a shift and activate control devices 114a-b (remote flight supervision computers for taking data from and providing commands to remotely controllable physical interaction devices 102a-b, the fighter drones), use remote control interfaces 112a-b to communicate over communication channels 110a-b token requests (e.g., requests for tokens of permission to send authorized commands to remotely controllable physical interaction devices 102a-b over communication channels 126a-b to perform tasks such as the reporting of data for specific targets and the administration of treatment (e.g., a missile through a fire control computer) to token distribution module 130 through client interface 118.

Upon receipt of a token request from one of control devices 114a-b (remote flight supervision server processes), token distribution module 130 compares the received request (for permission to fire a missile) to stored authorized requests listed in database 116 that are authorized to be fulfilled. For example, database 116 can include a listing of missiles authorized to be fired by remotely controllable physical interaction devices 102a-b (drones) to specific targets associated with those devices and the drone pilots whose control devices 114a-b (remote flight supervision computers identified by specific device ID, login of drone pilot using the device), are authorized to issue commands and control instructions to the remotely controllable physical interaction devices 102a-b in specific contexts (e.g., location of the device on a particular network at a particular time). For example, a remote flight supervision computer associated with a particular drone pilot could be authorized to order a missile fired at a particular hostile ship during the drone pilot's shift, if the remote flight supervision is located in the LAN of a particular submarine. But the remote flight supervision computer associated with that drone pilot could be forbidden from ordering weapon types, ordering strikes for other targets, ordering from a network outside the submarine, or ordering when the drone pilot is not on shift.

If the request from the one of control devices 114a-b (drone pilot's remote flight supervision computer process) is listed in the database as being authorized to be fulfilled, then token distribution module 130 sends a token over communication channels 110a-b (e.g., the battlefield network) to remote control interfaces 112a-b (on the drone pilot's computer) for subsequent use by control devices 114a-b (pilot's computer) in sending commands over communication channels 126a-b (for example, line of sight battlefield radio) to remotely controllable physical interaction devices 102a-b (drones).

In some embodiments, token distribution module 130 can ascertain whether to grant requests for tokens of permission to send authorized commands to remotely controllable physical interaction devices 102a-b (the drones) over communication channels 126a-b based on various factors. For example, requests for tokens of permission to send authorized commands to remotely controllable physical interaction devices 102a-b (the drones) over communication channels 126a-b can be considered based on one or a combination of hardware platform identification of control devices 114a-b (e.g., the MAC address of a particular remote flight supervision computer or a hardware serial number), network context of control devices 114a-b (the LAN in the submarine as opposed to a LAN in a hostile country), user identification (login ID of the drone pilot logged into or associated with one of remote flight supervision control devices 114a-b) requests for tokens of permission to send authorized commands to remotely controllable physical interaction devices 102a-b over communication channels 126a-b, time of day, type of command, and algorithmic risk analysis by token distribution module.

Upon receipt of tokens of permission to send authorized commands to remotely controllable physical interaction devices 102a-b (the drones) over communication channels 126a-b, remote control interfaces 112a-b (remote flight supervision computers) can send commands to remotely controllable physical interaction devices 102a-b (the drones) along with tokens of permission to send authorized commands to remotely controllable physical interaction devices 102a-b over communication channels 126a-b (satellite radio).

Remote command interfaces 122a-b of remotely controllable physical interaction devices 102a-b (the drones) receive commands to remotely controllable physical interaction devices 102a-b (e.g., ordering the drone to fire a missile) along with tokens of permission to send authorized commands to remotely controllable physical interaction devices 102a-b (the drones) over communication channels 126a-b (e.g., line of sight battlefield radio). Remotely controllable physical interaction devices 102a-b (the drones) then send token verification requests over communication channels 104a-b to command authentication module 120.

Upon receipt of token verification requests from remotely controllable physical interaction devices 102a-b (the drones), command authentication module 120 verifies that a particular token is currently authorized in association with a particular command to a particular one of remotely controllable physical interaction devices 102a-b (the drones) from a particular one of control devices 114a-b (remote flight supervision computers) and sends token verifications over communication channels 104a-b (network) indicating permission for control devices 114a-b (remote flight supervision computers) to send authorized commands to remotely controllable physical interaction devices 102a-b (the drones) over communication channels 126a-b (NFC, LAN, Wi-Fi).

Upon receipt of token verifications over communication channels 104a-b indicating permission for control devices 114a-b (remote flight supervision computers) to send authorized commands (to dispense drugs) to remotely controllable physical interaction devices 102a-b (the drones) over communication channels 126a-b, remotely controllable physical interaction devices 102a-b (the drones) execute the commands to (to fire missiles) remotely controllable physical interaction devices 102a-b (the drones) received over communication channels 126a-b (line of sight battlefield radio).

An alternative example of the process described above may provide additional clarification. Assume control devices 114a-b are remote flight supervision computers operated by drone pilots for taking data from and providing commands to remotely controllable physical interaction devices 102a-b, which are missile-armed drone aircraft.

When drone pilots log in for a shift and activate control devices 114a-b (remote flight supervision computers for taking data from and providing commands to remotely controllable physical interaction devices 102a-b, the fighter drones), use remote control interfaces 112a-b to communicate over communication channels 110a-b token requests (e.g., requests for tokens of permission to send authorized commands to remotely controllable physical interaction devices 102a-b over communication channels 126a-b to perform tasks such as the reporting of data for specific targets and the administration of treatment (e.g., a missile through a fire control computer) to token distribution module 130 through client interface 118.

Upon receipt of a token request from one of control devices 114a-b (remote flight supervision server processes), token distribution module 130 compares the received request (for permission to fire a missile) to stored authorized requests listed in database 116 that are authorized to be fulfilled. For example, database 116 can include a listing of missiles authorized to be fired by remotely controllable physical interaction devices 102a-b (drones) to specific targets associated with those devices and the drone pilots whose control devices 114a-b (remote flight supervision computers identified by specific device ID, login of drone pilot using the device), are authorized to issue commands and control instructions to the remotely controllable physical interaction devices 102a-b in specific contexts (e.g., location of the device on a particular network at a particular time). For example, a remote flight supervision computer associated with a particular drone pilot could be authorized to order a missile fired at a particular hostile ship during the drone pilot's shift, if the remote flight supervision is located in the LAN of a particular submarine. But the remote flight supervision computer associated with that drone pilot could be forbidden from ordering weapon types, ordering strikes for other targets, ordering from a network outside the submarine, or ordering when the drone pilot is not on shift.

If the request from the one of control devices 114a-b (drone pilot's remote flight supervision computer process) is listed in the database as being authorized to be fulfilled, then token distribution module 130 sends a token over communication channels 110a-b (e.g., the battlefield network) to remote control interfaces 112a-b (on the drone pilot's computer) for subsequent use by control devices 114a-b (pilot's computer) in sending commands over communication channels 126a-b (for example, line of sight battlefield radio) to remotely controllable physical interaction devices 102a-b (drones).

In some embodiments, token distribution module 130 can ascertain whether to grant requests for tokens of permission to send authorized commands to remotely controllable physical interaction devices 102a-b (the drones) over communication channels 126a-b based on various factors. For example, requests for tokens of permission to send authorized commands to remotely controllable physical interaction devices 102a-b (the drones) over communication channels 126a-b can be considered based on one or a combination of hardware platform identification of control devices 114a-b (e.g., the MAC address of a particular remote flight supervision computer or a hardware serial number), network context of control devices 114a-b (the LAN in the submarine as opposed to a LAN in a hostile country), user identification (login ID of the drone pilot logged into or associated with one of remote flight supervision control devices 114a-b) requests for tokens of permission to send authorized commands to remotely controllable physical interaction devices 102a-b over communication channels 126a-b, time of day, type of command, and algorithmic risk analysis by token distribution module.

Upon receipt of tokens of permission to send authorized commands to remotely controllable physical interaction devices 102a-b (the drones) over communication channels 126a-b, remote control interfaces 112a-b (remote flight supervision computers) can send commands to remotely controllable physical interaction devices 102a-b (the drones) along with tokens of permission to send authorized commands to remotely controllable physical interaction devices 102a-b over communication channels 126a-b (satellite radio).

Remote command interfaces 122a-b of remotely controllable physical interaction devices 102a-b (the drones) receive commands to remotely controllable physical interaction devices 102a-b (e.g., ordering the drone to fire a missile) along with tokens of permission to send authorized commands to remotely controllable physical interaction devices 102a-b (the drones) over communication channels 126a-b (e.g., line of sight battlefield radio). Remotely controllable physical interaction devices 102a-b (the drones) then send token verification requests over communication channels 104a-b to command authentication module 120.

Upon receipt of token verification requests from remotely controllable physical interaction devices 102a-b (the drones), command authentication module 120 verifies that a particular token is currently authorized in association with a particular command to a particular one of remotely controllable physical interaction devices 102a-b (the drones) from a particular one of control devices 114a-b (remote flight supervision computers) and sends token verifications over communication channels 104a-b (network) indicating permission for control devices 114a-b (remote flight supervision computers) to send authorized commands to remotely controllable physical interaction devices 102a-b (the drones) over communication channels 126a-b (NFC, LAN, Wi-Fi).

Upon receipt of token verifications over communication channels 104a-b indicating permission for control devices 114a-b (remote flight supervision computers) to send authorized commands (to dispense drugs) to remotely controllable physical interaction devices 102a-b (the drones) over communication channels 126a-b, remotely controllable physical interaction devices 102a-b (the drones) execute the commands to (to fire missiles) remotely controllable physical interaction devices 102a-b (the drones) received over communication channels 126a-b (line of sight battlefield radio).

A further alternative example of the process described above may provide clarification. Assume control devices 114a-b are nuclear power plant workstations operated by nuclear power technician for taking data from and providing commands to remotely controllable physical interaction devices 102a-b, which are parts of a nuclear reactor.

When nuclear power technicians log in for a shift and activate control devices 114a-b (nuclear power plant workstations for taking data from and providing commands to remotely controllable physical interaction devices 102a-b), use remote control interfaces 112a-b to communicate over communication channels 110a-b token requests (e.g., requests for tokens of permission to send authorized commands to remotely controllable physical interaction devices 102a-b over communication channels 126a-b to perform tasks such as the reporting of radiation and temperature data for specific groups of uranium rods and the adjustment of the plant (e.g., dropping control rods between fuel rods through a pneumatic control rod lift apparatus) to token distribution module 130 through client interface 118.

Upon receipt of a token request from one of control devices 114a-b (nuclear power plant workstations), token distribution module 130 compares the received request (for permission to take radiation and temperature data on a reactor core and adjust fuel rods in that reactor core) to stored authorized requests listed in database 116 that are authorized to be fulfilled. For example, database 116 can include a listing of control rod height settings authorized to be chosen by remotely controllable physical interaction devices 102a-b (pneumatic lifts) to specific reactor cores associated with those devices and the nuclear power technicians whose control devices 114a-b (nuclear power plant workstations identified by specific device ID, login of nuclear power technician using the device), are authorized to issue commands and control instructions to the remotely controllable physical interaction devices 102a-b in specific contexts (e.g., location of the device on a particular network at a particular time). For example, a nuclear power plant workstation associated with a particular nuclear power technician could be authorized to order raising rods in a particular reactor core during the nuclear power technician's shift, if the nuclear power plant workstation is located in the LAN of a particular reactor complex. But the nuclear power plant workstation associated with that nuclear power technician could be forbidden from ordering other settings of the rods, ordering settings of control rods in other reactor cores, ordering adjustment of water pumps, giving orders from the Wi-Fi network of the bar across the street from the plant, or ordering when the nuclear power technician is not on shift.

If the request from the one of control devices 114a-b (nuclear power technician's nuclear power plant workstation) is listed in the database as being authorized to be fulfilled, then token distribution module 130 sends a token over communication channels 110a-b (e.g., the power plant LAN) to remote control interfaces 112a-b (on the nuclear power technician's workstation) for subsequent use by control devices 114a-b (table) in sending commands over communication channels 126a-b (for example, the LAN of the power plant) to remotely controllable physical interaction devices 102a-b (the pneumatic lifts for moving the control rods).

In some embodiments, token distribution module 130 can ascertain whether to grant requests for tokens of permission to send authorized commands to remotely controllable physical interaction devices 102a-b (the pneumatic lifts for moving the control rods) over communication channels 126a-b based on various factors. For example, requests for tokens of permission to send authorized commands to remotely controllable physical interaction devices 102a-b (the pneumatic lifts for moving the control rods) over communication channels 126a-b can be considered based on one or a combination of hardware platform identification of control devices 114a-b (e.g., the MAC address of a particular nuclear power plant workstation or a hardware serial number), network context of control devices 114a-b (the LAN in the control room as opposed to the LAN in the breakroom), user identification (login ID of the nuclear power technician logged into or associated with one of nuclear power plant workstation control devices 114a-b) requests for tokens of permission to send authorized commands to remotely controllable physical interaction devices 102a-b over communication channels 126a-b, time of day, type of command, and algorithmic risk analysis by token distribution module.

Upon receipt of tokens of permission to send authorized commands to remotely controllable physical interaction devices 102a-b (the pneumatic lifts for moving the control rods) over communication channels 126a-b, remote control interfaces 112a-b (nuclear power plant workstations) can send commands to remotely controllable physical interaction devices 102a-b (the pneumatic lifts for moving the control rods) along with tokens of permission to send authorized commands to remotely controllable physical interaction devices 102a-b over communication channels 126a-b (the plant's LAN).

Remote command interfaces 122a-b of remotely controllable physical interaction devices 102a-b (the pneumatic lifts for moving the control rods) receive commands to remotely controllable physical interaction devices 102a-b (e.g., ordering the pneumatic lifts to adjust the control rods) along with tokens of permission to send authorized commands to remotely controllable physical interaction devices 102a-b (the pneumatic lifts for moving the control rods) over communication channels 126a-b (e.g., the power plant's LAN). Remotely controllable physical interaction devices 102a-b (the pneumatic lifts for moving the control rods) then send token verification requests over communication channels 104a-b to command authentication module 120.

Upon receipt of token verification requests from remotely controllable physical interaction devices 102a-b (the pneumatic lifts for moving the control rods), command authentication module 120 verifies that a particular token is currently authorized in association with a particular command to a particular one of remotely controllable physical interaction devices 102a-b (the pneumatic lifts for moving the control rods) from a particular one of control devices 114a-b (nuclear power plant workstations) and sends token verifications over communication channels 104a-b (network) indicating permission for control devices 114a-b (nuclear power plant workstations) to send authorized commands to remotely controllable physical interaction devices 102a-b (the pneumatic lifts for moving the control rods) over communication channels 126a-b (NFC, LAN, Wi-Fi).

Upon receipt of token verifications over communication channels 104a-b indicating permission for control devices 114a-b (nuclear power plant workstations) to send authorized commands (to move the control rods) to remotely controllable physical interaction devices 102a-b (the pneumatic lifts for moving the control rods) over communication channels 126a-b, remotely controllable physical interaction devices 102a-b (the pneumatic lifts for moving the control rods) execute the commands to (to move the control rods) remotely controllable physical interaction devices 102a-b (the drug dispensing robots) received over communication channels 126a-b (NFC, LAN, Wi-Fi).

Some embodiments include a token server (labeled authentication server 106) for offering token authentication as a remote service. In some embodiments a method for providing authentication of one or more control instructions from a control device 114a-b to a remotely-controllable physical interaction device 102a-b using a remote control authentication token includes receiving a request from a control device 114a-b for a transmission of a remote control authentication token. In some embodiments, the method further includes, responsive to the request from the control device for the remote control authentication token, verifying an identity of the control device 114a-b. In some embodiments, the verifying the identity of the control device 114a-b further includes comparing a pairing of a requesting identity credential of the control device 114a-b and a requesting network context of the control device 114a-b to expected values of pairings of requesting identity credentials and requesting network 108 contexts. In some embodiments, the method further includes, responsive to verifying the identity of the control device 114a-b, transmitting the remote control authentication token. In some embodiments, the transmitting of the remote control authentication token indicates permission for the control device 114a-b to send one or more control instructions to a remotely-controllable physical interaction device 102a-b.

Some embodiments support whitelisting. In some embodiments, comparing the pairing of the requesting identity credential of the control device 114a-b and the network 108 context of the control device 114a-b to expected values of the pairings of requesting identity credentials and requesting network 108 contexts further includes comparing the pairing of the requesting identity credential of the control device 114a-b and the requesting network 108 context of the control device 114a-b to expected values of the pairings of requesting identity credentials and requesting network 108 contexts for expected authorized pairings.

Some embodiments support analytics. In some embodiments, comparing the pairing of the requesting identity credential of the control device 114a-b and the network 108 context of the control device to expected values of the pairings of requesting identity credentials and requesting network contexts further includes comparing the pairing of the requesting identity credential of the control device 114a-b and the requesting network 108 context of the control device 114a-b to statistical risk models of expected values of the pairings of requesting identity credentials and requesting network 108 contexts. Some embodiments include an authentication server 106 separate from the token server (token distribution module 130).

In some embodiments, a method for providing authentication of one or more control instructions from a control device 114a-b to a remotely-controllable physical interaction device 102a-b using a remote control authentication token, includes receiving from a remotely-controllable physical interaction device 102a-b a token authentication request containing the remote control authentication token, verifying an authenticity of the remote control authentication token, and responsive to verifying the authenticity of the remote control authentication token, sending an authenticity verification message to the remotely-controllable physical interaction device 102a-b. In some embodiments, specific tokens are only authorized for specific command types.

In some embodiments, receiving from a remotely-controllable physical interaction device 102a-b a token authentication request containing the remote control authentication token further includes receiving from a remotely-controllable physical interaction device 102a-b a token authentication request containing the remote control authentication token and the one or more control instructions sent to the remotely-controllable physical interaction device 102a-b. In some embodiments, verifying an authenticity of the remote control authentication token further includes verifying the authenticity of the remote control authentication token with respect to authorization for the one or more control instructions sent to the remotely-controllable physical interaction device 102a-b.

Some embodiments support authentication differentiated with respect to whether a specific token is authorized from a specific sender identity. In some embodiments, receiving from a remotely-controllable physical interaction device a token authentication request containing the remote control authentication token further includes receiving from a remotely-controllable physical interaction device 102a-b a token authentication request containing the remote control authentication token and a sending identity credential of the control device 114a-b sending the one or more control instructions to the remotely-controllable physical interaction device 102a-b. In some embodiments, verifying an authenticity of the remote control authentication token further includes verifying an authenticity of the remote control authentication token with respect to authorization of the control device 114a-b sending the one or more control instructions to the remotely-controllable physical interaction device 102a-b.

In some embodiments, receiving from a remotely-controllable physical interaction device 102a-b a token authentication request containing the remote control authentication token further includes receiving from a remotely-controllable physical interaction device 102a-b a token authentication request containing the remote control authentication token and a sending network 108 context of the control device 114a-b sending the one or more control instructions to the remotely-controllable physical interaction device 102a-b. In some embodiments, verifying an authenticity of the remote control authentication token further includes verifying an authenticity of the remote control authentication token with respect to authorization of the control device 114a-b sending the one or more control instructions to the remotely-controllable physical interaction device from the sending network 108 context.

A method for providing authentication of one or more control instructions from a control device 114a-b to a remotely-controllable physical interaction device 102a-b using a remote control authentication token includes receiving at a remotely-controllable physical interaction device 102a-b one or more control instructions and a remote control authentication token of a sending control device 114a-b, sending from a server (authentication server 106) for providing authentication of one or more control instructions from a control device 114a-b to a remotely-controllable physical interaction device 102a-b using a remote control authentication token the token authentication request containing the remote control authentication token, and responsive to receiving at the remotely-controllable physical interaction device 102a-b an authenticity verification message from the server for providing authentication of one or more control instructions from a control device 114a-b to a remotely-controllable physical interaction device 102a-b using a remote control authentication token, executing the one or more control instructions on the remotely-controllable physical interaction device 102a-b.

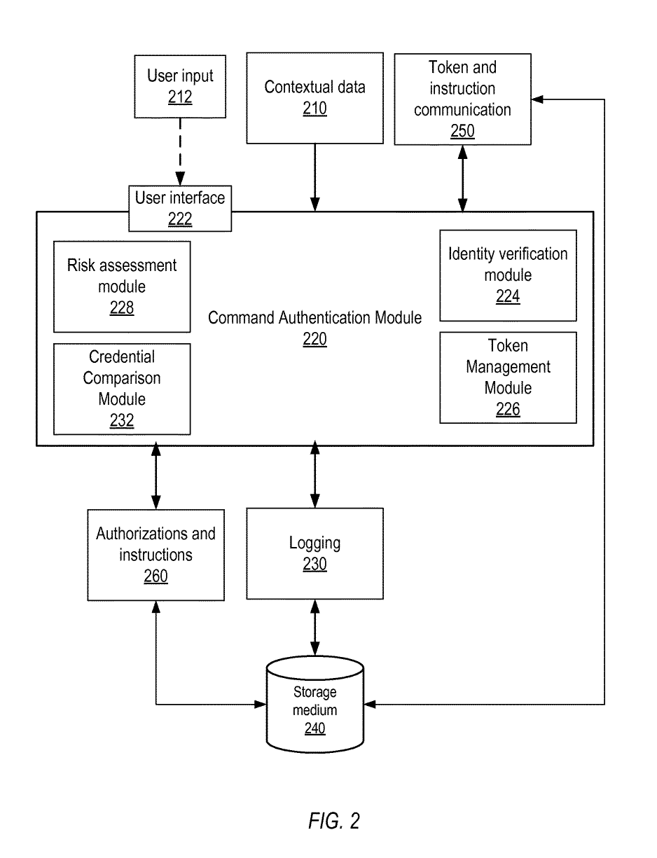

FIG. 2 depicts a module that may be used for implementing providing authentication of control instructions from a control device to a remotely-controllable physical interaction device using a remote control authentication token, according to some embodiments. In the depicted example embodiment, a command authentication module includes an identity verification module 224, a token management module 226, a credential comparison module 232 and a risk assessment module 228. A user interface 222 receives user input (e.g., commands) and command authentication module 220 receives contextual data 210 as well as token and instruction communication 250. Command authentication module generates authorizations and instructions 260 and performs logging 230, both of which are stored to a storage medium.

Some embodiments include a token server (command authentication module 220) for offering token authentication as a remote service. In some embodiments a method for providing authentication of one or more control instructions from a control device to a remotely-controllable physical interaction device using a remote control authentication token includes receiving (at user interface 222) a request from a control device for a transmission of a remote control authentication token (token and instruction communication 250). In some embodiments, the method further includes, responsive to the request from the control device (token and instruction communication 250) for the remote control authentication token, an identity verification module 224 verifying an identity of the control device (e.g., using contextual data 210). In some embodiments, the verifying the identity of the control device further includes a credential comparison module 232 comparing a pairing of a requesting identity credential of the control device and a requesting network context (e.g., using contextual data 210) of the control device to expected values of pairings of requesting identity credentials and requesting network contexts. In some embodiments, the method further includes, responsive to verifying the identity of the control device, a token management module 226 transmitting the remote control authentication token (in authorizations and instructions 260). In some embodiments, the token management module 226 transmitting the remote control authentication token (in authorizations and instructions 260) indicates permission for the control device to send one or more control instructions to a remotely-controllable physical interaction device.

Some embodiments support whitelisting. In some embodiments, comparing the pairing of the requesting identity credential of the control device and the network context (e.g., in contextual data 210) of the control device to expected values of the pairings of requesting identity credentials and requesting network contexts further includes an identity verification module 224 comparing the pairing of the requesting identity credential of the control device and the requesting network context of the control device to expected values of the pairings of requesting identity credentials and requesting network contexts for expected authorized pairings.

Some embodiments support analytics. In some embodiments, identity verification module 224 comparing the pairing of the requesting identity credential of the control device and the network context of the control device to expected values of the pairings of requesting identity credentials and requesting network contexts further includes risk assessment module 228 comparing the pairing of the requesting identity credential of the control device and the requesting network context of the control device to statistical risk models of expected values of the pairings of requesting identity credentials and requesting network contexts. Some embodiments include an authentication server separate from the token server. I

In some embodiments, a method for providing authentication of one or more control instructions from a control device to a remotely-controllable physical interaction device using a remote control authentication token, includes command authentication module 220 receiving from a remotely-controllable physical interaction device a token authentication request containing the remote control authentication token, identity verification module 220 verifying an authenticity of the remote control authentication token, and responsive to verifying the authenticity of the remote control authentication token, a token management module 226 sending an authenticity verification message to the remotely-controllable physical interaction device. In some embodiments, specific tokens are only authorized for specific command types.

In some embodiments, command authentication module 250 receiving from a remotely-controllable physical interaction device a token authentication request containing the remote control authentication token further includes command authentication module 250 receiving from a remotely-controllable physical interaction device a token authentication request containing the remote control authentication token and the one or more control instructions sent to the remotely-controllable physical interaction device. In some embodiments, identity verification module 224 verifying an authenticity of the remote control authentication token further includes identity verification module 224 verifying the authenticity of the remote control authentication token with respect to authorization for the one or more control instructions sent to the remotely-controllable physical interaction device.

Some embodiments support authentication differentiated with respect to whether a specific token is authorized from a specific sender identity. In some embodiments, command authentication module 250 receiving from a remotely-controllable physical interaction device a token authentication request containing the remote control authentication token further includes command authentication module 250 receiving from a remotely-controllable physical interaction device a token authentication request containing the remote control authentication token and a sending identity credential of the control device sending the one or more control instructions to the remotely-controllable physical interaction device. In some embodiments, identity verification module 224 verifying an authenticity of the remote control authentication token further includes identity verification module 224 verifying an authenticity of the remote control authentication token with respect to authorization of the control device sending the one or more control instructions to the remotely-controllable physical interaction device.

In some embodiments, receiving from a remotely-controllable physical interaction device a token authentication request containing the remote control authentication token further includes command authentication module 250 receiving from a remotely-controllable physical interaction device a token authentication request containing the remote control authentication token and a sending network context (contextual data 210) of the control device sending the one or more control instructions to the remotely-controllable physical interaction device. In some embodiments, identity verification module 224 verifying an authenticity of the remote control authentication token further includes identity verification module 224 verifying an authenticity of the remote control authentication token with respect to authorization of the control device sending the one or more control instructions to the remotely-controllable physical interaction device from the sending network context.

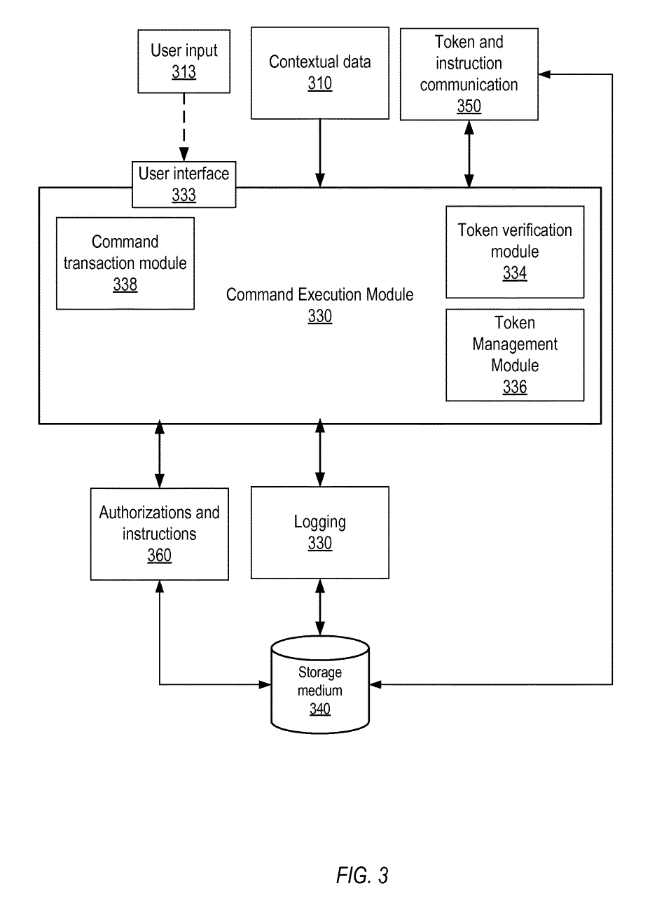

FIG. 3 illustrates a module that may be used for implementing providing authentication of control instructions from a control device to a remotely-controllable physical interaction device using a remote control authentication token, according to some embodiments. Command execution module 330 contains a token management module 336, a command transaction module 338, a user interface 333 for receiving user input 313, and a token verification module 334. Command execution module 330 receives token and instruction communication 350 and contextual data 360 while generating authorizations and instructions 360 and logging 360.

In some embodiments, command execution module 330 executes a method for providing authentication of one or more control instructions from a control device to a remotely-controllable physical interaction device using a remote control authentication token. Command execution module 330 includes a user interface 333 for receiving at a remotely-controllable physical interaction device one or more control instructions and a token management module for receiving a remote control authentication token of a sending control device. Token management module 336 sends from a server for providing authentication of one or more control instructions from a control device to a remotely-controllable physical interaction device using a remote control authentication token the token authentication request containing the remote control authentication token. Responsive to receiving at the remotely-controllable physical interaction device an authenticity verification message from the server for providing authentication of one or more control instructions from a control device to a remotely-controllable physical interaction device using a remote control authentication token, command transaction module 338 executes the one or more control instructions on the remotely-controllable physical interaction device.

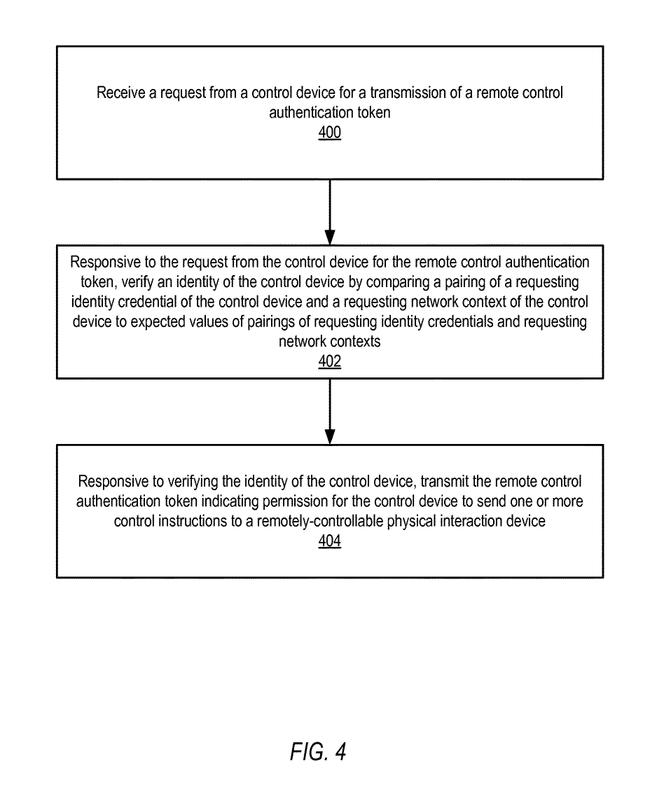

FIG. 4 is a high-level logical flowchart of operations that can be used for implementing providing authentication of control instructions from a control device to a remotely-controllable physical interaction device using a remote control authentication token, according to some embodiments. A request from a control device for a transmission of a remote control authentication token is received (block 400). Responsive to the request from the control device for the remote control authentication token, an identity of the control device is verified by comparing a pairing of a requesting identity credential of the control device and a requesting network context of the control device to expected values of pairings of requesting identity credentials and requesting network contexts (block 402). Responsive to verifying the identity of the control device, the remote control authentication token indicating permission for the control device to send one or more control instructions to a remotely-controllable physical interaction device is transmitted (block 404).

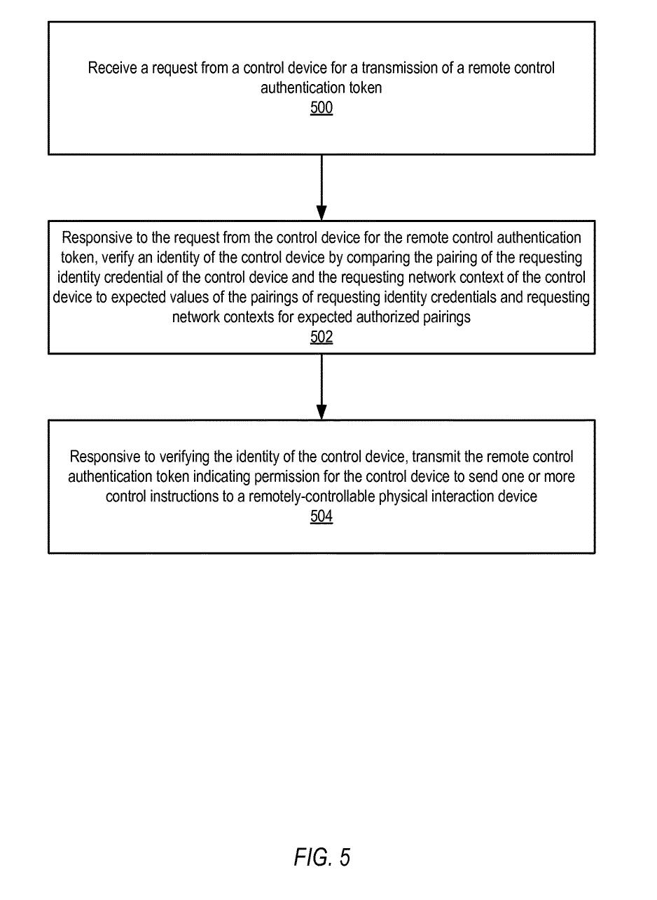

FIG. 5 is a high-level logical flowchart of operations that can be used for implementing providing authentication of control instructions from a control device to a remotely-controllable physical interaction device using a remote control authentication token, according to some embodiments. A request from a control device for a transmission of a remote control authentication token is received (block 500). Responsive to the request from the control device for the remote control authentication token, an identity of the control device is verified by comparing the pairing of the requesting identity credential of the control device and the requesting network context of the control device to expected values of the pairings of requesting identity credentials and requesting network contexts for expected authorized pairings (block 502). Responsive to verifying the identity of the control device, the remote control authentication token indicating permission for the control device to send one or more control instructions to a remotely-controllable physical interaction device is transmitted (block 504).

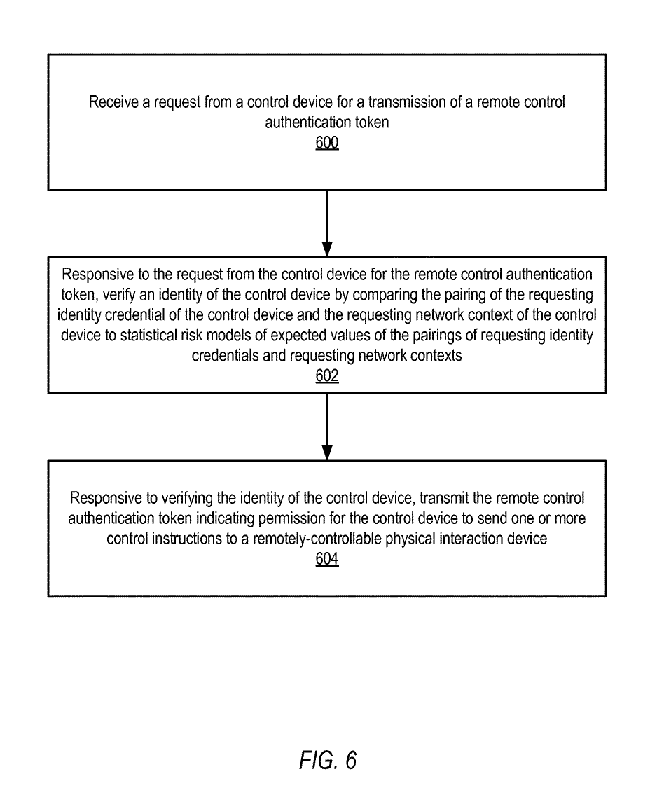

FIG. 6 is a high-level logical flowchart of operations that can be used for implementing providing authentication of control instructions from a control device to a remotely-controllable physical interaction device using a remote control authentication token, according to some embodiments. A request from a control device for a transmission of a remote control authentication token is received (block 600). Responsive to the request from the control device for the remote control authentication token, an identity of the control device is verified by comparing the pairing of the requesting identity credential of the control device and the requesting network context of the control device to statistical risk models of expected values of the pairings of requesting identity credentials and requesting network contexts (block 602). Responsive to verifying the identity of the control device, the remote control authentication token indicating permission for the control device to send one or more control instructions to a remotely-controllable physical interaction device is transmitted (block 604).

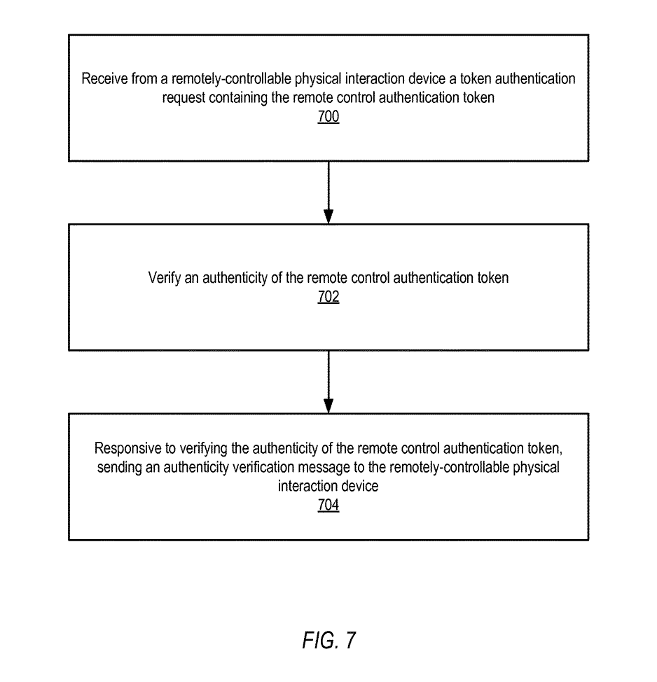

FIG. 7 is a high-level logical flowchart of operations that can be used for implementing providing authentication of control instructions from a control device to a remotely-controllable physical interaction device using a remote control authentication token, according to some embodiments. A token authentication request containing the remote control authentication token is received from a remotely-controllable physical interaction device (block 700). An authenticity of the remote control authentication token (block 702). Responsive to verifying the authenticity of the remote control authentication token, an authenticity verification message is sent to the remotely-controllable physical interaction device (block 704).

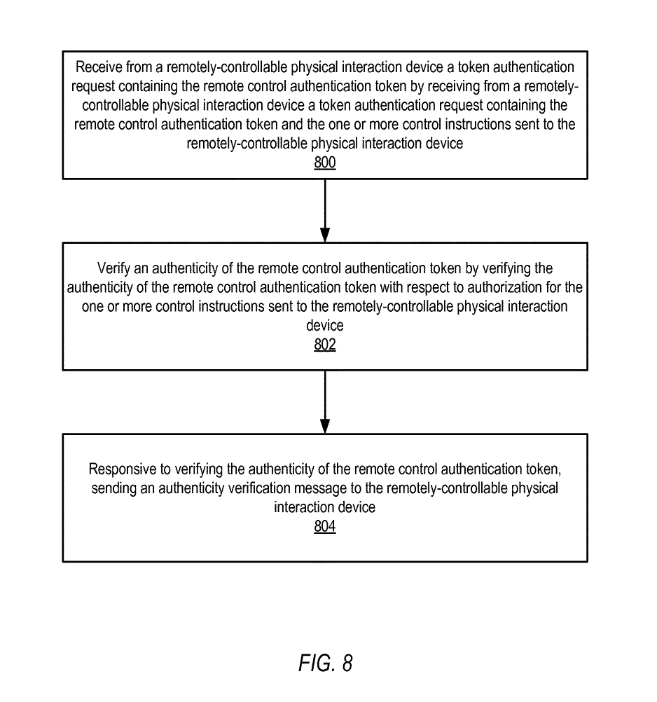

FIG. 8 is a high-level logical flowchart of operations that can be used for implementing providing authentication of control instructions from a control device to a remotely-controllable physical interaction device using a remote control authentication token, according to some embodiments. A token authentication request containing the remote control authentication token is received from a remotely-controllable physical interaction device by receiving from a remotely-controllable physical interaction device a token authentication request containing the remote control authentication token and the one or more control instructions sent to the remotely-controllable physical interaction device (block 800). An authenticity of the remote control authentication token is verified by verifying the authenticity of the remote control authentication token with respect to authorization for the one or more control instructions sent to the remotely-controllable physical interaction device (block 802). Responsive to verifying the authenticity of the remote control authentication token, an authenticity verification message is sent to the remotely-controllable physical interaction device (block 804).

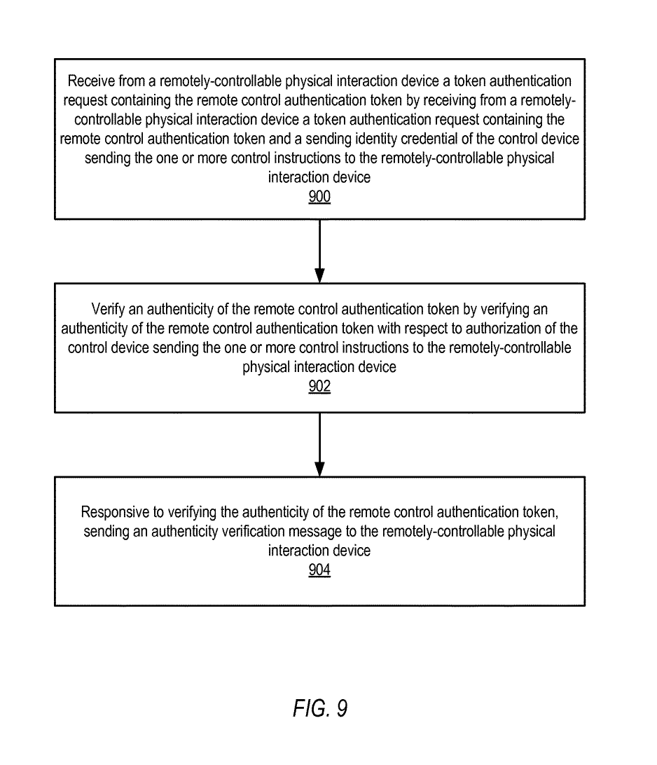

FIG. 9 is a high-level logical flowchart of operations that can be used for implementing providing authentication of control instructions from a control device to a remotely-controllable physical interaction device using a remote control authentication token, according to some embodiments. A token authentication request containing the remote control authentication token and a sending identity credential of the control device sending the one or more control instructions to the remotely-controllable physical interaction device are received from a remotely-controllable physical interaction device a token authentication request containing the remote control authentication token (block 900). An authenticity of the remote control authentication token is verified by verifying an authenticity of the remote control authentication token with respect to authorization of the control device sending the one or more control instructions to the remotely-controllable physical interaction device (block 902). Responsive to verifying the authenticity of the remote control authentication token, an authenticity verification message is sent to the remotely-controllable physical interaction device (block 904).

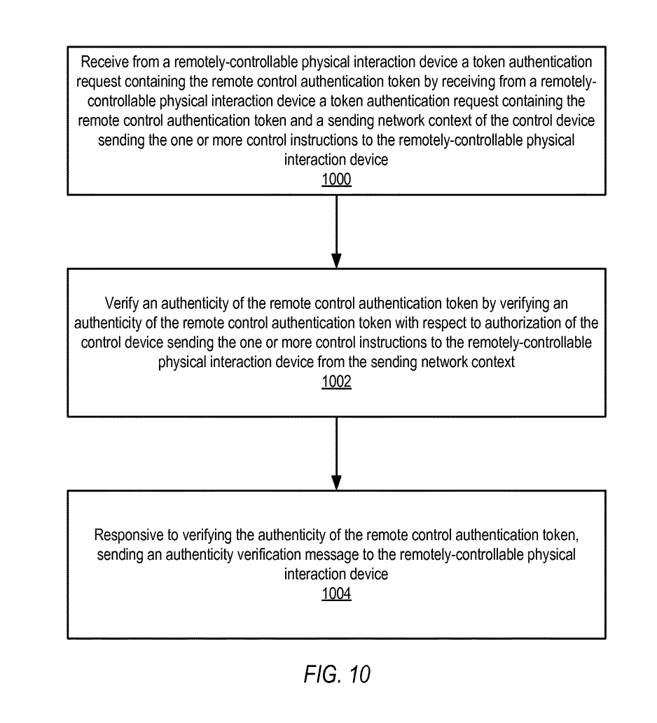

FIG. 10 is a high-level logical flowchart of operations that can be used for implementing providing authentication of control instructions from a control device to a remotely-controllable physical interaction device using a remote control authentication token, according to some embodiments. A token authentication request containing the remote control authentication token is received from a remotely-controllable physical interaction device by receiving from a remotely-controllable physical interaction device a token authentication request containing the remote control authentication token and a sending network context of the control device sending the one or more control instructions to the remotely-controllable physical interaction device (block 1000). An authenticity of the remote control authentication token is verified by verifying an authenticity of the remote control authentication token with respect to authorization of the control device sending the one or more control instructions to the remotely-controllable physical interaction device from the sending network context (block 1002). Responsive to verifying the authenticity of the remote control authentication token, an authenticity verification message is sent to the remotely-controllable physical interaction device (block 1004).

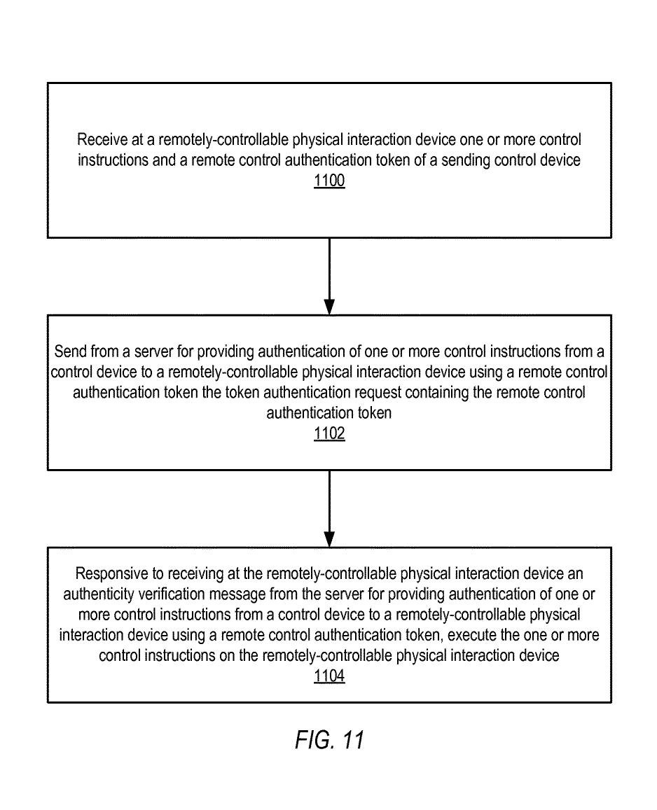

FIG. 11 is a high-level logical flowchart of operations that can be used for implementing providing authentication of control instructions from a control device to a remotely-controllable physical interaction device using a remote control authentication token, according to some embodiments. One or more control instructions and a remote control authentication token of a sending control device are received at a remotely-controllable physical interaction device (block 1100). The token authentication request containing the remote control authentication token is sent from a server for providing authentication of one or more control instructions from a control device to a remotely-controllable physical interaction device using a remote control authentication token (block 1102). Responsive to receiving at the remotely-controllable physical interaction device an authenticity verification message from the server for providing authentication of one or more control instructions from a control device to a remotely-controllable physical interaction device using a remote control authentication token, the one or more control instructions on the remotely-controllable physical interaction device is executed (block 1104).

### Example System

Embodiments of a system and method for tracking, managing and reporting revenue capital transactions as described herein may be executed on one or more computer systems, which may interact with various other devices. One such computer system is illustrated by FIG. 6. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1060, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a transaction management module are shown stored within system memory 1020 as program instructions 1026 and data storage 1036, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1060. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1060 may, in some embodiments, include one or more display terminals, keyboards, keypads, touchpads, scanning devices, voice or optical recognition devices, or any other devices suitable for entering or retrieving data by one or more computer system 1000. Multiple input/output devices 1060 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 6, memory 1020 may include program instructions 1026, configured to implement embodiments of a transaction management module as described herein, and data storage 1036, including various data accessible by program instructions 1026. In one embodiment, program instructions 1026 may include software elements of embodiments of a transaction management module as illustrated in the above Figures. Data storage 1036 may include data that may be used in embodiments. In other embodiments, other or different software elements and data may be included.

Those skilled in the art will appreciate that computer system 1000 is merely illustrative and is not intended to limit the scope of a transaction management module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method for providing authentication of one or more control instructions from a control device to a remotely-controllable physical interaction device using a remote control authentication token, the method comprising:
receiving a request from a control device for a transmission of a remote control authentication token;
responsive to the request from the control device for the remote control authentication token, verifying an identity of the control device, wherein
the verifying the identity of the control device further comprises
comparing a pairing of a requesting identity credential of the control device and a requesting network context of the control device to expected values of pairings of requesting identity credentials and requesting network contexts;
responsive to verifying the identity of the control device, transmitting the remote control authentication token, wherein
the transmitting of the remote control authentication token indicates permission for the control device to send one or more control instructions to a remotely-controllable physical interaction device.

2. The method of claim 1, wherein
comparing the pairing of the requesting identity credential of the control device and the network context of the control device to expected values of the pairings of requesting identity credentials and requesting network contexts further comprises:
comparing the pairing of the requesting identity credential of the control device and the requesting network context of the control device to expected values of the pairings of requesting identity credentials and requesting network contexts for expected authorized pairings.

3. The method of claim 1, wherein
comparing the pairing of the requesting identity credential of the control device and the network context of the control device to expected values of the pairings of requesting identity credentials and requesting network contexts further comprises:
comparing the pairing of the requesting identity credential of the control device and the requesting network context of the control device to statistical risk models of expected values of the pairings of requesting identity credentials and requesting network contexts.

4. The method of claim 1, further comprising:
receiving from a remotely-controllable physical interaction device a token authentication request containing the remote control authentication token;
verifying an authenticity of the remote control authentication token; and
responsive to verifying the authenticity of the remote control authentication token, sending an authenticity verification message to the remotely-controllable physical interaction device.

5. The method of claim 4, wherein:
receiving from a remotely-controllable physical interaction device a token authentication request containing the remote control authentication token further comprises
receiving from a remotely-controllable physical interaction device a token authentication request containing the remote control authentication token and the one or more control instructions sent to the remotely-controllable physical interaction device; and
verifying an authenticity of the remote control authentication token further comprises
verifying the authenticity of the remote control authentication token with respect to authorization for the one or more control instructions sent to the remotely-controllable physical interaction device.

6. The method of claim 4, wherein:
receiving from a remotely-controllable physical interaction device a token authentication request containing the remote control authentication token further comprises
receiving from a remotely-controllable physical interaction device a token authentication request containing the remote control authentication token and a sending identity credential of the control device sending the one or more control instructions to the remotely-controllable physical interaction device; and
verifying an authenticity of the remote control authentication token further comprises
verifying an authenticity of the remote control authentication token with respect to authorization of the control device sending the one or more control instructions to the remotely-controllable physical interaction device.

7. The method of claim 4, wherein:
receiving from a remotely-controllable physical interaction device a token authentication request containing the remote control authentication token further comprises
receiving from a remotely-controllable physical interaction device a token authentication request containing the remote control authentication token and a sending network context of the control device sending the one or more control instructions to the remotely-controllable physical interaction device; and
verifying an authenticity of the remote control authentication token further comprises
verifying an authenticity of the remote control authentication token with respect to authorization of the control device sending the one or more control instructions to the remotely-controllable physical interaction device from the sending network context.

8. A non-transitory computer-readable storage medium storing program instructions, wherein the program instructions are computer-executable to implement:
receiving a request from a control device for a transmission of a remote control authentication token;
responsive to the request from the control device for the remote control authentication token, verifying an identity of the control device, wherein
the program instructions computer-executable to implement verifying the identity of the control device further comprise
program instructions computer-executable to implement a pairing of a requesting identity credential of the control device and a requesting network context of the control device to expected values of pairings of requesting identity credentials and requesting network contexts;
responsive to verifying the identity of the control device, transmitting the remote control authentication token, wherein
the transmitting of the remote control authentication token indicates permission for the control device to send one or more control instructions to a remotely-controllable physical interaction device.

9. The non-transitory computer-readable storage medium of claim 8, wherein
the program instructions computer-executable to implement comparing the pairing of the requesting identity credential of the control device and the network context of the control device to expected values of the pairings of requesting identity credentials and requesting network contexts further comprise:
program instructions computer-executable to implement comparing the pairing of the requesting identity credential of the control device and the requesting network context of the control device to expected values of the pairings of requesting identity credentials and requesting network contexts for expected authorized pairings.

10. The non-transitory computer-readable storage medium of claim 8, wherein
the program instructions computer-executable to implement comparing the pairing of the requesting identity credential of the control device and the network context of the control device to expected values of the pairings of requesting identity credentials and requesting network contexts further comprise:
program instructions computer-executable to implement comparing the pairing of the requesting identity credential of the control device and the requesting network context of the control device to statistical risk models of expected values of the pairings of requesting identity credentials and requesting network contexts.

11. The non-transitory computer-readable storage medium of claim 8, wherein the program instructions are computer-executable to implement
receiving from a remotely-controllable physical interaction device a token authentication request containing the remote control authentication token;
verifying an authenticity of the remote control authentication token; and
responsive to verifying the authenticity of the remote control authentication token, sending an authenticity verification message to the remotely-controllable physical interaction device.

12. The non-transitory computer-readable storage medium of claim 11, wherein:
the program instructions computer-executable to implement receiving from a remotely-controllable physical interaction device a token authentication request containing the remote control authentication token further comprise
the program instructions computer-executable to implement receiving from a remotely-controllable physical interaction device a token authentication request containing the remote control authentication token and the one or more control instructions sent to the remotely-controllable physical interaction device; and
the program instructions computer-executable to implement verifying an authenticity of the remote control authentication token further comprise
program instructions computer-executable to implement verifying the authenticity of the remote control authentication token with respect to authorization for the one or more control instructions sent to the remotely-controllable physical interaction device.

13. The non-transitory computer-readable storage medium of claim 11, wherein:
the program instructions computer-executable to implement receiving from a remotely-controllable physical interaction device a token authentication request containing the remote control authentication token further comprise
program instructions computer-executable to implement receiving from a remotely-controllable physical interaction device a token authentication request containing the remote control authentication token and a sending identity credential of the control device sending the one or more control instructions to the remotely-controllable physical interaction device; and
the program instructions computer-executable to implement verifying an authenticity of the remote control authentication token further comprise
program instructions computer-executable to implement verifying an authenticity of the remote control authentication token with respect to authorization of the control device sending the one or more control instructions to the remotely-controllable physical interaction device.

14. The non-transitory computer-readable storage medium of claim 11, wherein:
the program instructions computer-executable to implement receiving from a remotely-controllable physical interaction device a token authentication request containing the remote control authentication token further comprise
program instructions computer-executable to implement receiving from a remotely-controllable physical interaction device a token authentication request containing the remote control authentication token and a sending network context of the control device sending the one or more control instructions to the remotely-controllable physical interaction device; and
the program instructions computer-executable to implement verifying an authenticity of the remote control authentication token further comprise
program instructions computer-executable to implement verifying an authenticity of the remote control authentication token with respect to authorization of the control device sending the one or more control instructions to the remotely-controllable physical interaction device from the sending network context.

15. A system for providing authentication of one or more control instructions from a control device to a remotely-controllable physical interaction device using a remote control authentication token, the system comprising:
a processor; and
a non-transitory storage medium storing program instructions, wherein the program instructions are executable by the processor to implement:
receiving a request from a control device for a transmission of a remote control authentication token,
responsive to the request from the control device for the remote control authentication token, verifying an identity of the control device, wherein
the program instructions executable by the processor to implement verifying the identity of the control device further comprise
program instructions executable by the processor to implement comparing a pairing of a requesting identity credential of the control device and a requesting network context of the control device to expected values of pairings of requesting identity credentials and requesting network contexts,
responsive to verifying the identity of the control device, transmitting the remote control authentication token, wherein
the transmitting of the remote control authentication token indicates permission for the control device to send one or more control instructions to a remotely-controllable physical interaction device.

16. The system of claim 15, wherein
the program instructions executable by the processor to implement comparing the pairing of the requesting identity credential of the control device and the network context of the control device to expected values of the pairings of requesting identity credentials and requesting network contexts further comprise:
program instructions executable by the processor to implement comparing the pairing of the requesting identity credential of the control device and the requesting network context of the control device to expected values of the pairings of requesting identity credentials and requesting network contexts for expected authorized pairings.

17. The system of claim 15, wherein
the program instructions executable by the processor to implement comparing the pairing of the requesting identity credential of the control device and the network context of the control device to expected values of the pairings of requesting identity credentials and requesting network contexts further comprise:
program instructions executable by the processor to implement comparing the pairing of the requesting identity credential of the control device and the requesting network context of the control device to statistical risk models of expected values of the pairings of requesting identity credentials and requesting network contexts.

18. The system of claim 15, wherein:
the program instructions are further executable by the processor to implement:
receiving from a remotely-controllable physical interaction device a token authentication request containing the remote control authentication token;
verifying an authenticity of the remote control authentication token; and
responsive to verifying the authenticity of the remote control authentication token, sending an authenticity verification message to the remotely-controllable physical interaction device.

19. The system of claim 18, wherein:
the program instructions executable by the processor to implement receiving from a remotely-controllable physical interaction device a token authentication request containing the remote control authentication token further comprise
program instructions executable by the processor to implement receiving from a remotely-controllable physical interaction device a token authentication request containing the remote control authentication token and the one or more control instructions sent to the remotely-controllable physical interaction device; and
the program instructions executable by the processor to implement verifying an authenticity of the remote control authentication token further comprise program instructions executable by the processor to implement verifying the authenticity of the remote control authentication token with respect to authorization for the one or more control instructions sent to the remotely-controllable physical interaction device.

20. The system of claim 18, wherein:
the program instructions executable by the processor to implement receiving from a remotely-controllable physical interaction device a token authentication request containing the remote control authentication token further comprise
program instructions executable by the processor to implement receiving from a remotely-controllable physical interaction device a token authentication request containing the remote control authentication token and a sending identity credential of the control device sending the one or more control instructions to the remotely-controllable physical interaction device; and
the program instructions executable by the processor to implement verifying an authenticity of the remote control authentication token further comprise
program instructions executable by the processor to implement verifying an authenticity of the remote control authentication token with respect to authorization of the control device sending the one or more control instructions to the remotely-controllable physical interaction device.
